(19) United States
(12) Patent Application Publication
(10) Pub. No.: US 2025/0285398 A1
(43) Pub. Date: Sep. 11, 2025

(54) METHOD AND APPARATUS FOR PROCESSING IMAGE, COMPUTER DEVICE, AND STORAGE MEDIUM

(71) Applicant: Tencent Technology (Shenzhen) Company Limited, Shenzhen (CN)

(72) Inventors: Xiaoyu PAN, Shenzhen (CN); Junnan SHAO, Shenzhen (CN); Chen SU, Shenzhen (CN); Chaoyu HUA, Shenzhen (CN); Kaihang GAO, Shenzhen (CN); Liang KANG, Shenzhen (CN); Yongjia ZHANG, Shenzhen (CN); Xiao HU, Shenzhen (CN); Zhuqing XIAO, Shenzhen (CN); Bingxiao LIU, Shenzhen (CN); Haoke PENG, Shenzhen (CN); Jiahui DING, Shenzhen (CN); Lanxi ZHOU, Shenzhen (CN); Wenbin ZHANG, Shenzhen (CN); Chengyu WU, Shenzhen (CN); Fei XU, Shenzhen (CN); Danxing XU, Shenzhen (CN)

(21) Appl. No.: 19/218,058

(22) Filed: May 23, 2025

Related U.S. Application Data
(63) Continuation of application No. PCT/CN2024/078684, filed on Feb. 27, 2024.

(30) Foreign Application Priority Data
Apr. 28, 2023 (CN) 202310487377.3

(51) Int. Cl. G06T 19/20; A63F 13/69

(52) U.S. Cl. CPC G06T 19/20; A63F 13/69; G06T 2219/2012

(57) ABSTRACT

A method for processing an image executed by a computer device includes: obtaining a target rendering style, the target rendering style including style information, and color configuration information and color change information of each texture partition under the target rendering style; determining, according to the style information, first position information of each pixel on a target object under the target rendering style; determining, according to the first position information of each pixel under the target rendering style, a target texture partition to which the pixel belongs; determining a color of each pixel on the target object according to color configuration information of the target texture partition, color change information of the target texture partition, and second position information of the pixel on the target object under the target rendering style; and mapping the color of each pixel on the target object to a region on a display screen.

### CROSS-REFERENCE TO RELATED APPLICATIONS

This application is a continuation application of PCT Patent Application No. PCT/CN2024/078684, entitled “METHOD AND APPARATUS FOR PROCESSING IMAGE, COMPUTER DEVICE, AND STORAGE MEDIUM” filed on Feb. 27, 2024, which claims the priority to Chinese patent application No. 2023104873773, entitled “Method and apparatus for processing image, computer device, and storage medium” filed on Apr. 28, 2023, both of which are incorporated in their entirety herein by reference.

### FIELD OF THE TECHNOLOGY

This application relates to the technical field of image processing, and particularly relates to a method and apparatus for processing an image, a computer device, a storage medium, and a computer program product.

### BACKGROUND OF THE DISCLOSURE

With the development of smart terminals, an increasing variety of applications are installable on the smart terminals, for example, a shopping application, a navigation application, a social application, and a game application. In the game application, a virtual character is designed to be increasingly realistic, attracting a wider range of game players.

In a conventional technology, the game application provides a dyeing function, through which a user can dye a to-be-rendered user a favored color. However, the dyeing function provided by the conventional technology is monotonous, and fails to satisfy a personalized dyeing requirement of the user.

### SUMMARY

This application provides a method and apparatus for processing an image, a computer device, a computer-readable storage medium, and a computer program product.

In an aspect, this application provides a method for processing an image executed by a computer device. The method includes the following operations:
obtaining a target rendering style, the target rendering style including style information, and color configuration information and color change information of each texture partition under the target rendering style;
determining, according to the style information, first position information of each pixel on a target object under the target rendering style;
determining, according to the first position information of each pixel under the target rendering style, a target texture partition to which each pixel belongs;
determining a color of each pixel on the target object according to color configuration information of the target texture partition, color change information of the target texture partition, and second position information of the pixel on the target object under the target rendering style; and
mapping the color of each pixel on the target object to a region on a display screen.

In yet another aspect, this application further provides a computer device. The computer device includes a memory and a processor, the memory storing a computer program that, when executed by the processor, causes the computer device to perform the method for processing an image.

In yet another aspect, this application further provides a non-transitory computer-readable storage medium. The computer-readable storage medium has a computer program stored therein that, when being executed by a processor, causes the computer device to perform the method for processing an image.

Details of one or more embodiments of this application will be provided in the accompanying drawings and descriptions below. Other features, objectives, and advantages of this application become apparent from the description, the drawings, and the claims.

### BRIEF DESCRIPTION OF THE DRAWINGS

In order to more clearly illustrate technical solutions in embodiments of this application or in the conventional technology, the accompanying drawings required for the description of the embodiments or in the conventional technology will be briefly introduced below. Clearly, the accompanying drawings in the following description are only the embodiments of this application, and those of ordinary skill in the art would also be able to derive other drawings from these drawings without making creative efforts.

FIG. 1 is an application environment diagram of a method for processing an image in an embodiment;

FIG. 2 is a schematic flowchart of a method for processing an image in an embodiment;

FIG. 3 is a schematic diagram of a texture partition in an embodiment;

FIG. 4 is a schematic diagram of a region division manner in an embodiment;

FIG. 5 is a schematic diagram of a region division manner in another embodiment;

FIG. 6 is a schematic diagram of a setting page of hair of a virtual character in an embodiment;

FIG. 7 is a schematic diagram of a hue combination configuration region in an embodiment;

FIG. 8 is a schematic diagram of a color attribute configuration region in an embodiment;

FIG. 9 is a schematic diagram of a color change configuration region in an embodiment;

FIG. 10 is a schematic diagram of a hair style design region in an embodiment;

FIG. 11 is a schematic diagram of a color computation principle in an embodiment;

FIG. 12 is a schematic flowchart of generating an image corresponding to a target object in an embodiment;

FIG. 13 is a schematic diagram of effect presentation corresponding to vertical gradient change in an embodiment;

FIG. 14 is a schematic diagram of effect presentation corresponding to lateral gradient change in an embodiment;

FIG. 15 is a schematic diagram of a principle of updating a rendering material in an embodiment;

FIG. 16 is a schematic diagram of effect presentation corresponding to highlighting in an embodiment;

FIG. 17 is a structural block diagram of an apparatus for processing an image in an embodiment; and

FIG. 18 is a diagram of an internal structure of a computer device in an embodiment.

### DESCRIPTION OF EMBODIMENTS

Technical solutions of embodiments of this application will be clearly and completely described below in conjunction with the accompanying drawings of the embodiments of this application. Clearly, the embodiments described are merely some embodiments rather than all embodiments of this application. Based on the embodiments of this application, all other embodiments obtained by those of ordinary skill in the art without making creative efforts fall within the protection scope of this application.

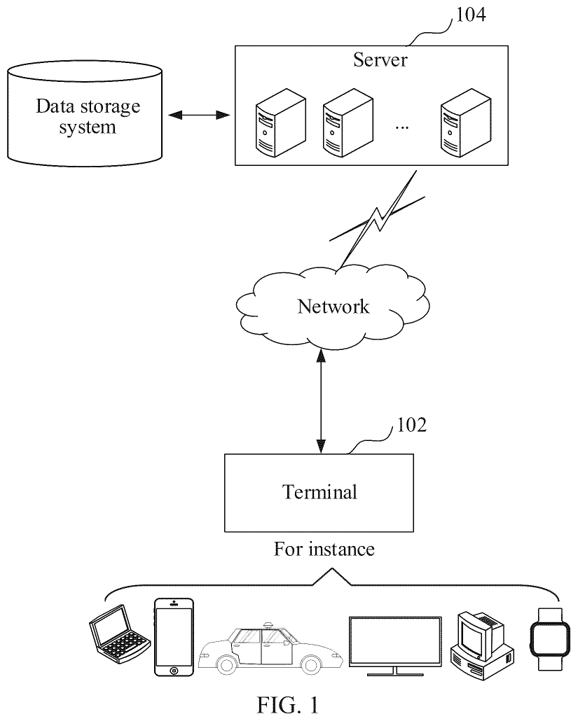

A method for processing an image according to an embodiment of this application may be applied to an application environment shown in FIG. 1. A terminal 102 is in communication with a server 104 through a network. A data storage system may store data that needs to be processed by the server 104. The data storage system may be integrated on the server 104, or placed on a cloud or other servers. The method for processing an image according to the embodiment of this application may be executed by the terminal 102 or the server 104 independently, or executed by the terminal 102 and the server 104 collaboratively. With a case that the method is independently executed by the terminal 102 as an example, the terminal 102 may determine a target rendering style, obtain style information of the target rendering style, and color configuration information and color change information of each texture partition under the target rendering style, then determine, according to the style information, first position information of each pixel on a target object under the target rendering style, determine, according to the first position information of each pixel under the target rendering style, a target texture partition to which each pixel belongs, then determine a color of each pixel on the target object according to color configuration information of the target texture partition, color change information of the target texture partition, and second position information of each pixel on the target object under the target rendering style, and finally map the color of each pixel on the target object to a region on a display screen, and generate an image corresponding to the target object.

The terminal 102 may be, but is not limited to, various personal computers, notebook computers, smart phones, tablet computers, Internet of Things devices and portable wearable devices. The Internet of Things devices may be smart speakers, smart televisions, smart air conditioners, smart in-vehicle devices, etc. The portable wearable devices may be smart watches, smart bracelets, headsets, etc. The server 104 may be an independent physical server, a server cluster or a distributed system composed of a plurality of physical servers, or a cloud server providing cloud computing services.

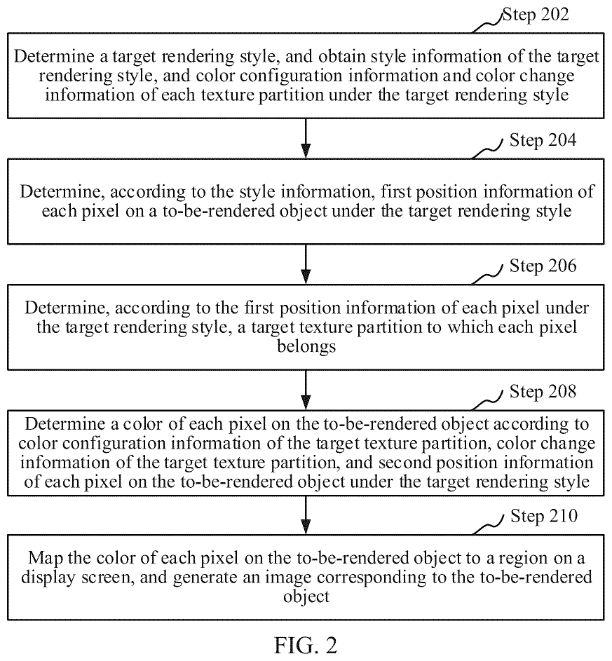

In some embodiments, as shown in FIG. 2, a method for processing an image is provided. With a case that the method is applied to the terminal in FIG. 1 as an example, description is provided. The method includes the following operations:

Operation 202: Determine a target rendering style, and obtain style information of the target rendering style, and color configuration information and color change information of each texture partition under the target rendering style.

The terminal may be configured with applications (APPs) having different functions, for example, a shopping APP, a social APP, an image processing APP, and a game APP. The method for processing an image according to the embodiment of this application may be applied to the image processing APP, or may be applied to the game APP, which is not limited in the embodiment of this application.

The target rendering style may be a rendering style specified by a user through a rendering style specifying function of a corresponding APP. The style information of the target rendering style may be information configured for describing a feature of the target rendering style. The style information of the target rendering style may include a style identifier, a style name, style description, etc. of the target rendering style, and is not limited in the embodiment of this application.

In specific implementation, the target rendering style may be a gradient color style of the target object specified by the user through the rendering style specifying function of the corresponding APP. The target object may be a hair style, clothing, etc. of a virtual character. The virtual character may be a virtual character corresponding to an account used for the user to log in to the corresponding APP. The gradient color style is used for representing a gradient color manner. The gradient color style includes, for example, lateral gradient change, vertical gradient change, intermediate gradient change, highlighting, etc. The gradient color style is not limited by the embodiments of this application.

For example, when the method for processing an image according to the embodiment of this application is applied to a game APP, a user may log in to the game APP through an account, a setting page of hair of a virtual character is opened on the game APP, the setting page of the hair of the virtual character displays the virtual character corresponding to the account used during login, the target object is a hair style of the virtual character, the setting page of the hair of the virtual character further provides a rendering style specifying control, the user may execute a rendering style specifying operation through the control, and the game APP may use a specified rendering style corresponding to the rendering style specifying operation as a target rendering style of the hair style of the virtual character, and use style information of the specified rendering style as style information of the target rendering style.

The texture partition is a region included in a two-dimensional image editing interface in software for making a model, and the two-dimensional image editing interface includes an abscissa axis and an ordinate axis. The abscissa axis or may be referred to as a texture abscissa axis, and the ordinate axis or may be referred to as a texture ordinate axis. The two-dimensional image editing interface may be divided into a plurality of regions according to a preset rule.

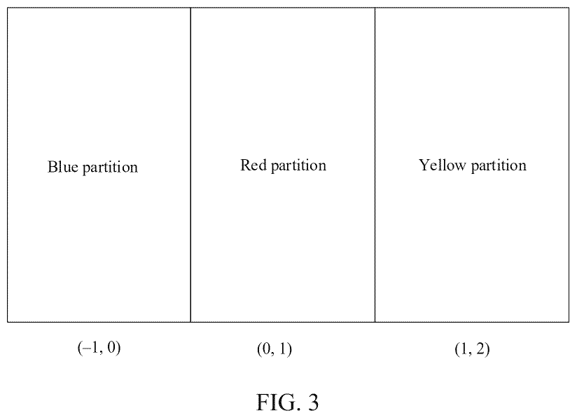

In specific implementation, with reference to FIG. 3, a range of the texture abscissa axis is [−1, 2]. A region whose texture abscissa is (−1, 0) may be used as a texture partition. For convenience of description, the texture partition may be referred to as a blue partition. A region whose texture abscissa is (0, 1) is used as another texture partition. For convenience of description, the texture partition may be referred to as a red partition. A region whose texture abscissa is (1, 2) is used as another texture partition. For convenience of description, the texture partition may be referred to as a yellow partition. Thus, the two-dimensional image editing interface may be divided into three texture partitions.

In a development stage, the target object may be divided into to-be-rendered regions whose quantity is matched with a quantity of texture partitions in a division manner, and the to-be-rendered regions may be placed in different texture partitions, such that a texture abscissa and a texture ordinate of each pixel on the target object in the division manner are obtained. Alternatively, the target object may be divided into to-be-rendered regions whose quantity is matched with a quantity of texture partitions in another division manner, and the to-be-rendered regions may be placed in different texture partitions, such that a texture abscissa and a texture ordinate of each pixel on the target object in the division manner are obtained. Each division manner corresponds to one rendering style. The same pixel has different texture coordinates in different division manners. The style information may be configured for each division manner. After a texture abscissa and a texture ordinate of each pixel on the target object are obtained, the texture abscissa and the texture ordinate of each pixel may be used as texture coordinate data, and style information and texture coordinate data corresponding to a corresponding division manner may be stored as a group of gradient data.

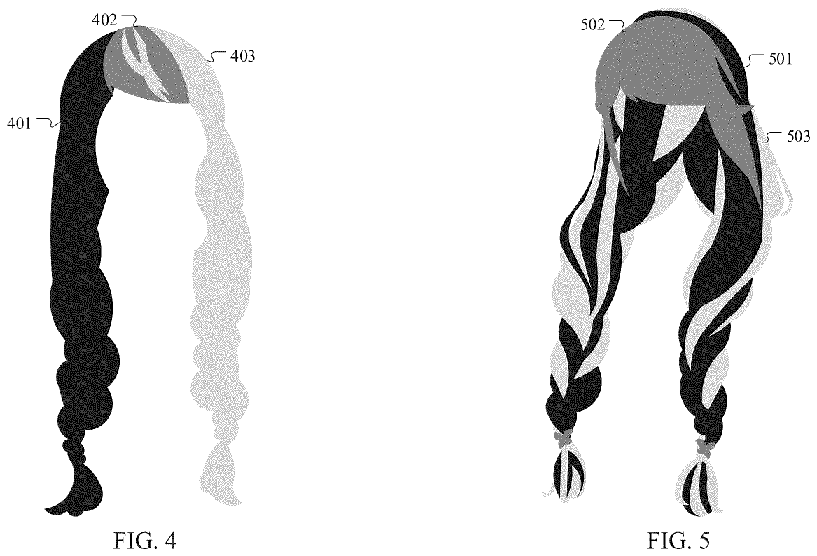

For example, as shown in FIG. 4, the target object is a hair style of a virtual character, and the hair style is left and right braids. In the development stage, a plotter may divide the hair style of the virtual character into a black region 401, a dark gray region 402, and a light gray region 403 in a left-middle-right division manner. The black region 401 may be placed in the blue partition, the dark gray region 402 may be placed in the yellow partition, and the light gray region 403 may be placed in the red partition. Thus, the texture abscissa and the texture ordinate of each pixel on the hair style are obtained. Alternatively, as shown in FIG. 5, the plotter may divide the hair style of the virtual character into a black region 501, a dark gray region 502, and a light gray region 503 in a braid division manner. The black region 501 may be placed in the blue partition, the dark gray region 502 may be placed in the yellow partition, and the light gray region 503 may be placed in the red partition. Thus, the texture abscissa and the texture ordinate of each pixel on the hair style are obtained.

The color configuration information of each texture partition under the target rendering style may include hue combination information of the texture partition specified by the user, and color attribute information specified by the user for each color in the hue combination information. The color attribute information may include main and secondary attributes, value, saturation, etc., and is not limited in the embodiment of this application.

The color change information of each texture partition may include information specified by the user for the texture partition and configured for limiting a gradient region. The information may include, for example, a gradient position and a gradient range.

For example, with reference to the examples, after the user executes the rendering style specifying operation, the game APP may display a hue combination configuration region and a color change configuration region. The hue combination configuration region includes a hue combination configuration control corresponding to each texture partition under the target rendering style. The user may configure a hue combination for the texture partition through the hue combination configuration control corresponding to each texture partition. The game APP obtains the hue combination information of the texture partition based on the configuration operation. After configuring the hue combination for each texture partition, the user may trigger a color attribute configuration region expansion operation in the hue combination configuration region. The game APP expands a color attribute configuration region in response to the expansion operation. The color attribute configuration region includes an attribute adjustment region corresponding to each texture partition. The user may adjust a color attribute of each color included in corresponding hue combination information through the attribute adjustment region. The game APP obtains the color attribute information based on the adjustment operation. The color change configuration region includes a color change configuration control corresponding to each texture partition under the target rendering style. The user may set a color change of each texture partition through the color change configuration control corresponding to the texture partition. The game APP obtains the color change information of the texture partition based on the setting operation.

Operation 204: Determine, according to the style information, the first position information of each pixel on the target object under the target rendering style.

Operation 206: Determine, according to the first position information of each pixel under the target rendering style, the target texture partition to which each pixel belongs.

The terminal stores a plurality of groups of gradient data, and each group of gradient data includes style information and texture coordinate data. Based on the plurality of groups of gradient data, the first position information of each pixel on the target object under the target rendering style may be determined.

In specific implementation, after obtaining the style information of the target rendering style, the terminal may match the obtained style information with style information in each group of gradient data. After the successfully matched style information is found, gradient data to which the successfully matched style information belongs is obtained, and the texture coordinate data in the gradient data is obtained. The texture abscissa of each pixel in the texture coordinate data may be used as the first position information of the corresponding pixel.

The terminal may obtain a position range corresponding to each texture partition under the target rendering style, and may obtain a position range into which first position information of each pixel on the target object falls. A texture partition corresponding to the position range is used as a target texture partition to which the pixel belongs.

For example, 3 texture partitions exist under the target rendering style, where a texture abscissa range of one texture partition is (−1, 0), a texture abscissa range of another texture partition is (0, 1), and a texture abscissa range of a third texture partition (1, 2). After the texture abscissa of each pixel on the target object under the target rendering style is determined, a range within which a texture abscissa of each pixel on the target object falls may be determined, and a texture partition corresponding to the range is used as the target texture partition to which the pixel belongs.

Operation 208: Determine the color of each pixel on the target object according to the color configuration information of the target texture partition, the color change information of the target texture partition, and the second position information of each pixel on the target object under the target rendering style.

The color configuration information of the target texture partition may include hue combination information of the texture partition specified by the user, and color attribute information specified by the user for each color in the hue combination information. The color change information of the target texture partition may include: information specified by the user for the texture partition and configured for limiting a gradient region. For example, the information may include the gradient position and the gradient range.

The terminal stores a plurality of groups of gradient data. Each group of gradient data includes the style information and the texture coordinate data. After obtaining the style information of the target rendering style, the terminal may match the obtained style information with style information in each group of gradient data. Gradient data to which the successfully matched style information belongs is obtained, and the texture coordinate data in the gradient data is obtained. The texture abscissa of each pixel in the texture coordinate data may be used as the first position information of the corresponding pixel. The texture ordinate may be used as the second position information of the corresponding pixel.

After obtaining the color configuration information of the target texture partition, the color change information of the target texture partition, and the second position information of each pixel on the target object under the target rendering style, the terminal may compute the color of each pixel on the target object through a preset formula.

The terminal may obtain a main partition color and a secondary partition color of a target texture partition to which each pixel on the target object belongs, and determine a color of the pixel based on the main partition color, the secondary partition color, second position information of the pixel under the target rendering style, and color change information of the target texture partition to which the pixel belongs.

Operation 210: Map the color of each pixel on the target object to the region on the display screen, and generate the image corresponding to the target object.

There is a correspondence between a pixel on the target object and a pixel point on a region used for displaying the target object on the display screen. After a color of each pixel on a to-be-rendered image is obtained, the color of each pixel on the to-be-rendered image may be mapped to the pixel point on the region according to the correspondence, and an image corresponding to the target object may be generated based on the color of each pixel on the region.

In some embodiments, each pixel on the target object corresponds to a pixel point on a region used for displaying the target object on the display screen. A color of each pixel on the target object may be used as a color of a corresponding pixel point, and the image corresponding to the target object may be generated based on the color of each pixel point on the region.

In some embodiments, each pixel on the target object corresponds to a plurality of pixel points on a region used for displaying the target object on the display screen. A color of each pixel on the target object may be used as colors of a plurality of corresponding pixel points, and the image corresponding to the target object may be generated based on the color of each pixel point on the region.

After generating an image corresponding to the target object, the terminal may display the image on the display screen for the user to view. For example, the target object may be the hair style of the virtual character. After generating an image corresponding to the hair style of the virtual character, the terminal may display the image on the display screen for the user to view. In this way, the user may preview a presentation effect of the target object in real time under the style information, the color configuration information, and the color change information.

In the embodiment, the target rendering style is determined, the style information of the target rendering style, and the color configuration information and the color change information of each texture partition under the target rendering style are obtained, and according to the style information, the first position information of each pixel on the target object under the target rendering style is determined; according to the first position information of each pixel under the target rendering style, the target texture partition to which each pixel belongs is determined; the color of each pixel on the target object is determined according to the color configuration information of the target texture partition, the color change information of the target texture partition, and the second position information of each pixel on the target object under the target rendering style; and the color of each pixel on the target object is mapped to the region on the display screen, and the image corresponding to the target object is generated. The image of the generated target object corresponds to the target rendering style, and different rendering styles correspond to different image presentation effects. This manner provides a selection entry of a rendering style for a user, such that the user may select a most appropriate rendering style from a plurality of rendering styles. Thus, personalized design experience of the user for the target object is improved, dyeing diversity is improved, and a problem of low dyeing efficiency caused by repeated dyeing adjustment in a case of a monotonous dyeing function is solved.

In some embodiments, the operations of determining the target rendering style, and obtaining the style information of the target rendering style, and the color configuration information and the color change information of each texture partition under the target rendering style include the following operations: use, in response to a rendering style specifying operation, a specified rendering style corresponding to the rendering style specifying operation as a target rendering style, and use style information of the specified rendering style as style information of the target rendering style; and display a rendering configuration region corresponding to the target rendering style, and obtain the color configuration information and the color change information of each texture partition under the target rendering style through the rendering configuration region.

The user may execute the rendering style specifying operation on a page including the rendering style specifying function. The terminal may use, in response to the rendering style specifying operation, the specified rendering style corresponding to the rendering style specifying operation as the target rendering style, and use the style information of the specified rendering style as the style information of the target rendering style.

In specific implementation, the terminal is configured with a game APP. The method for processing an image according to the embodiment of this application may be applied to the game APP, the user may log in to the game APP through an account, a setting page of hair of a virtual character is opened on the game APP, the setting page of the hair of the virtual character displays the virtual character corresponding to the account used during login, the target object is a hair style of the virtual character, the setting page of the hair of the virtual character further provides a rendering style specifying control, the user may execute a rendering style specifying operation through the rendering style specifying control, and the game APP may use a specified rendering style corresponding to the rendering style specifying operation as a target rendering style of the hair style of the virtual character, and use style information of the specified rendering style as style information of the target rendering style.

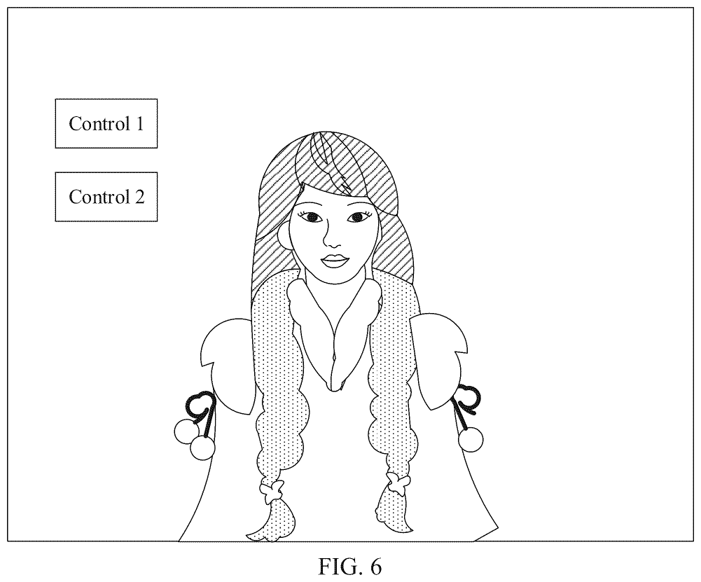

For example, as shown in FIG. 6, the target object may be the hair style of the virtual character. The setting page of the hair of the virtual character is provided with the rendering style specifying control. The rendering style specifying control includes a control 1 and a control 2. The control 1 is a control corresponding to vertical gradient change, and the control 2 is a control corresponding to lateral gradient change. Assuming that the user executes a trigger operation on the control 1, the game APP uses vertical gradient change as the target rendering style, and uses style information of the vertical gradient change as the style information of the target rendering style. Assuming that the user executes a trigger operation on the control 2, the game APP uses lateral gradient change as the target rendering style, and uses the style information of the lateral gradient change as the style information of the target rendering style.

After the user executes the rendering style specifying operation on the page including the rendering style specifying function, the terminal may display the rendering configuration region corresponding to the target rendering style on the page. The user may execute a rendering configuration operation in the rendering configuration region. The terminal may determine the color configuration information and the color change information of each texture partition under the target rendering style based on the rendering configuration operation.

In the embodiment, the user is allowed to execute the rendering style specifying operation on a specific page, and in response to the rendering style specifying operation, the terminal uses the specified rendering style corresponding to the rendering style specifying operation as the target rendering style, and uses the style information of the specified rendering style as the style information of the target rendering style. Moreover, the rendering configuration region corresponding to the target rendering style is displayed, and the color configuration information and the color change information of each texture partition under the target rendering style are obtained through the rendering configuration region. This manner provides a selection entry of a rendering style for the user, such that the user may select a most appropriate rendering style from a plurality of rendering styles. Thus, personalized design experience of the user for the target object is improved.

In some embodiments, the rendering configuration region includes a hue combination configuration region, a color change configuration region, and a color attribute configuration region. The operations of displaying the rendering configuration region corresponding to the target rendering style, and obtaining the color configuration information and the color change information of each texture partition under the target rendering style through the rendering configuration region include the following operations: obtain hue combination information of each texture partition under the target rendering style through a hue combination configuration region; obtain color attribute information of each color included in the hue combination information through the color attribute configuration region; determine, based on the hue combination information and the color attribute information, color configuration information of each texture partition under the target rendering style; and obtain the color change information of each texture partition under the target rendering style through the color change configuration region.

The terminal may display the hue combination configuration region, the color change configuration region and the color attribute configuration region on the page including the rendering style specifying function. Alternatively, the terminal may display the hue combination configuration region on the page including the rendering style specifying function. After the user executes a hue combination configuration operation in the hue combination configuration region and triggers a region skipping operation, a color control and a gradient control are displayed. After the user executes a trigger operation on the color control, the terminal displays the color attribute configuration region. After the user executes a trigger operation on the gradient control, the terminal displays the color change configuration region.

The hue combination configuration region includes a hue combination configuration control corresponding to each texture partition under the target rendering style. The user may execute a hue combination configuration operation through the hue combination configuration control corresponding to each texture partition, such that a hue combination is configured for the texture partition.

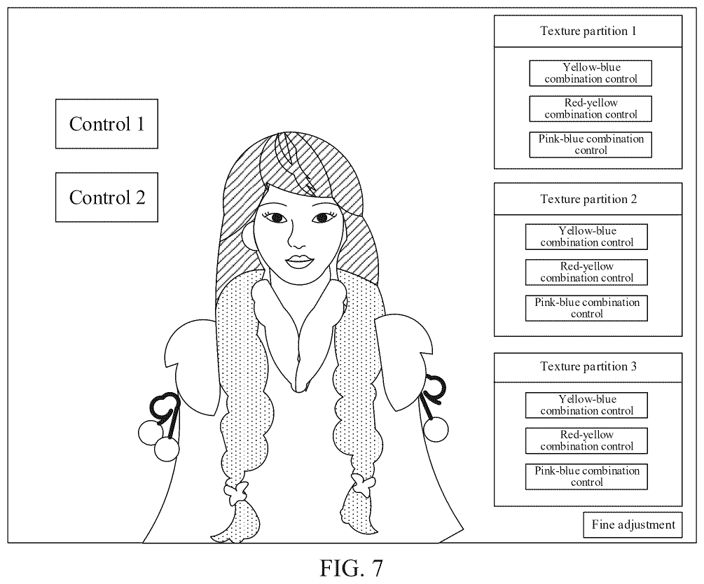

For example, with reference to FIG. 7, assuming that there are 3 texture partitions, that is, a texture partition 1, a texture partition 2, and a texture partition 3. In the hue combination configuration region, the texture partition 1, the texture partition 2 and the texture partition 3 each correspond to a hue combination selection region. Each hue combination region includes a plurality of hue combination configuration controls, for example, a yellow-blue combination control, a red-yellow combination control, and a pink-blue combination control. The user may click on the hue combination configuration control to configure a hue combination for a corresponding texture partition. For example, if the user clicks on the yellow-blue combination control in a hue combination selection region corresponding to the texture partition 1, the terminal may use yellow and blue as hue combination information of the texture partition 1; if the user clicks on the red-yellow combination control in a hue combination selection region corresponding to the texture partition 2, the terminal may use red and yellow as hue combination information of the texture partition 2; and if the user clicks on the pink-blue combination control in a hue combination selection region corresponding to the texture partition 3, the terminal may use pink and blue as hue combination information of the texture partition 3.

After obtaining the hue combination information of each texture partition and the color attribute information of each color included in the hue combination information, the terminal may use the hue combination information and the color attribute information as the color configuration information of the corresponding texture partition.

In the embodiment, the hue combination information of each texture partition under the target rendering style may be obtained through the hue combination configuration region; the color attribute information of each color included in the hue combination information may be obtained through the color attribute configuration region; based on the hue combination information and the color attribute information, the color configuration information of each texture partition under the target rendering style may be determined; and the color change information of each texture partition under the target rendering style may be obtained through the color change configuration region. This manner provides a selection entry of parameters such as a hue combination, a color attribute and a color change for the user, and further improves personalized design experience for the target object.

In some embodiments, the color attribute configuration region includes an attribute adjustment control of each color in the hue combination information. The operation of obtaining the color attribute information of each color included in the hue combination information through the color attribute configuration region includes the following operation: determine, based on a touch operation on the attribute adjustment control, the color attribute information of each color included in the hue combination information.

The attribute adjustment control may include a value adjustment control and a saturation adjustment control. Value of a corresponding color may be determined based on a touch operation on the value adjustment control. Saturation of the corresponding color may be determined based on a touch operation on the saturation adjustment control. Color attribute information of the corresponding color may be determined based on the value and the saturation.

The color attribute configuration region may further include a main-secondary color specifying control. The user may specify main and secondary attributes of each color in the hue combination information through the main-secondary color specifying control. The terminal may use a color obtained through the value adjustment control, saturation obtained through the saturation adjustment control, and the main and secondary attributes obtained through the main-secondary color specifying control as the color attribute information of the corresponding color.

The color attribute configuration region includes an attribute specifying region corresponding to each texture partition. Each attribute specifying region includes an attribute adjustment control of each color in hue combination information corresponding to a corresponding texture partition.

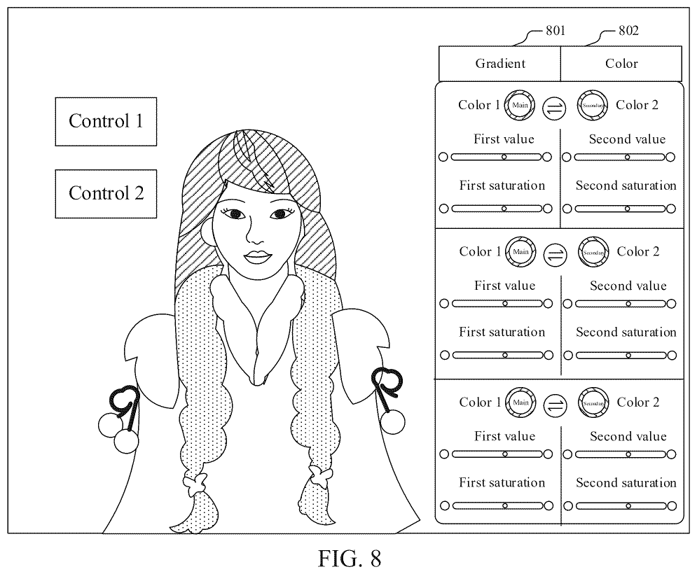

For example, after executing the hue combination configuration operation in the hue combination configuration region, the user may click on a fine adjustment control in FIG. 7, that is, may trigger the region skipping operation. With reference to FIG. 8, in response to a clicking operation, the terminal may display a gradient control 801 and a color control 802. After the user clicks on the color control 802, the terminal may display the color attribute configuration region. Assuming that there are 3 texture partitions, which include a texture partition 1, a texture partition 2, and a texture partition 3, in the color attribute configuration region, the texture partition 1, the texture partition 2 and the texture partition 3 each correspond to an attribute specifying region. The attribute specifying region corresponding to the texture partition 1 includes a main-secondary color specifying control, and a value adjustment control and a saturation adjustment control of each color in hue combination information corresponding to the texture partition 1. The user may specify main and secondary attributes of each color in the hue combination information corresponding to the texture partition 1 through the main-secondary color specifying control, adjust value of each color through the value adjustment control of each color, and adjust saturation of each color through the saturation adjustment control of each color. Similarly, the attribute specifying region corresponding to the texture partition 2 includes a main-secondary color specifying control, and a value adjustment control and a saturation adjustment control of each color in hue combination information corresponding to the texture partition 2. The user may specify main and secondary attributes of each color in the hue combination information corresponding to the texture partition 2 through the main-secondary color specifying control, adjust value of each color through the value adjustment control of each color, and adjust saturation of each color through the saturation adjustment control of each color. Similar to the above texture partitions, the texture partition 3 will not be repeated in the embodiment of this application.

In the embodiment, the color attribute configuration region is configured with the attribute adjustment control. The user may adjust parameters such as value and saturation of each color through the attribute adjustment control. This manner provides a selection entry of parameters such as a value and saturation for the user, such that the user may freely set value and saturation of a color, and personalized design experience of the user for the target object is improved.

In some embodiments, the color change configuration region includes a color change control of each texture partition under the target rendering style. The operation of obtaining the color change information of each texture partition under the target rendering style through the color change configuration region includes the following operation: determine, based on a touch operation on the color change control, the color change information of each texture partition under the target rendering style.

The color change control includes a gradient position adjustment control and a gradient range adjustment control. A gradient position of a corresponding texture partition may be determined based on a touch operation on the gradient position adjustment control, and a gradient range of the corresponding texture partition may be determined based on a touch operation on the gradient range adjustment control. The terminal may use the gradient position and the gradient range as color change information of the corresponding texture partition.

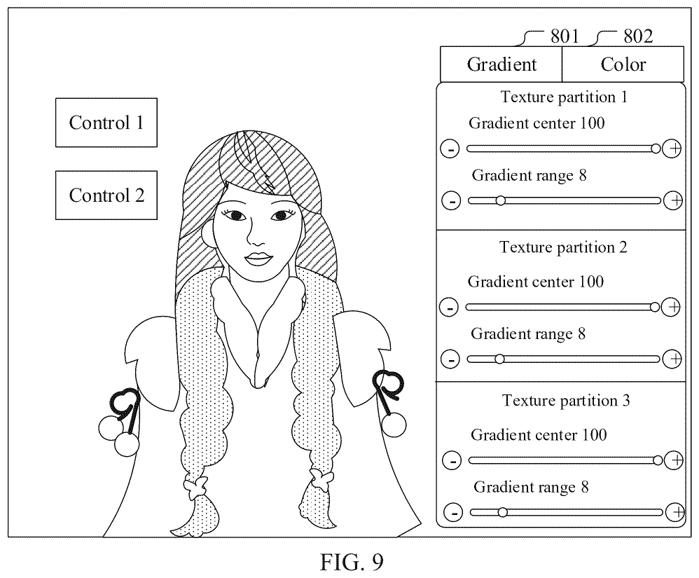

For example, with reference to FIG. 9, after the user clicks on the color control 802, the terminal may display the color change configuration region. Assuming that there are 3 texture partitions, which include a texture partition 1, a texture partition 2, and a texture partition 3, in the color change configuration region, the texture partition 1, the texture partition 2 and the texture partition 3 each correspond to a color change specifying region. The color change specifying region corresponding to the texture partition 1 includes a gradient position adjustment control and a gradient range adjustment control. The user may adjust a gradient position corresponding to the texture partition 1 through the gradient position adjustment control. The terminal may determine the gradient position corresponding to the texture partition 1 according to an adjustment operation. The user may adjust a gradient range corresponding to the texture partition 1 through the gradient range adjustment control. The terminal may determine the gradient range corresponding to the texture partition 1 according to an adjustment operation. Similarly, the color change specifying region corresponding to the texture partition 2 includes a gradient position adjustment control and a gradient range adjustment control. The user may adjust a gradient position corresponding to the texture partition 2 through the gradient position adjustment control. The terminal may determine the gradient position corresponding to the texture partition 2 according to an adjustment operation. The user may adjust a gradient range corresponding to the texture partition 2 through the gradient range adjustment control. The terminal may determine the gradient range corresponding to the texture partition 2 according to an adjustment operation. Similar to the above texture partitions, the texture partition 3 will not be repeated in the embodiment of this application.

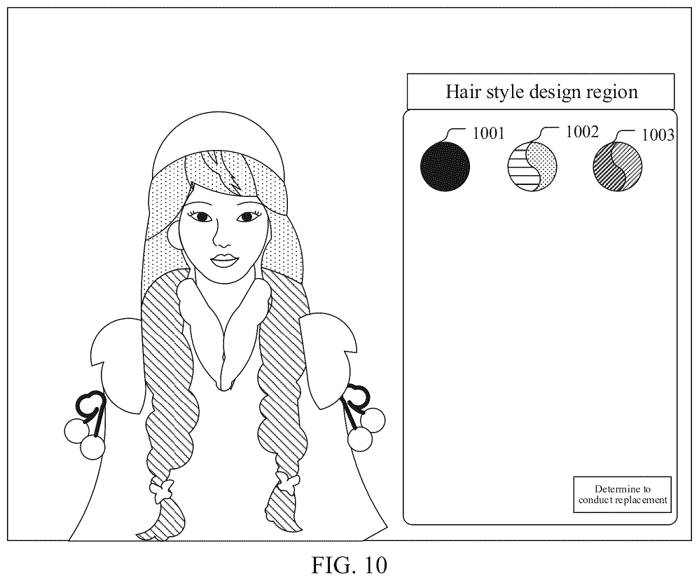

The terminal may store the obtained style information, the obtained color configuration information, and the obtained color change information, and generate a corresponding trigger control in a user design region. When the user clicks on the trigger control, the terminal directly generates the image corresponding to the target object based on stored data. For example, the target object is the hair style of the virtual character. The terminal may generate a corresponding trigger control in a hair style design region. When there are a plurality of groups of stored data, there are a plurality of corresponding trigger controls, such as a hair dyeing control 1001, a hair dyeing control 1002, and a hair dyeing control 1003 in FIG. 10. Assuming that the user clicks on the hair dyeing control 1001 and clicks to determine to conduct replacement, the terminal may generate the image corresponding to the target object based on data corresponding to the hair dyeing control 1001, and display the image on the display screen.

In the embodiment, the color change configuration region is configured with the color change control. The user may adjust the gradient position and the gradient range corresponding to the texture partition through the color change control. This manner provides a selection entry of the gradient position and the gradient range for the user, such that the user may freely set the gradient position and the gradient range of the texture partition, and personalized design experience of the user for the target object is improved.

In some embodiments, the operation of determining, according to the style information, the first position information of each pixel on the target object under the target rendering style includes the following operations: seek, according to the style information, texture coordinate data corresponding to a target object and matched with the style information; and seek a texture abscissa of each pixel on the target object from the texture coordinate data, and use the texture abscissa of each pixel as first position information of a corresponding pixel under the target rendering style.

The style information of the target rendering style may include a style identifier, a style name, style description, etc. of the target rendering style.

In a development stage, a plotter may divide the to-be-rendered image in different division manners, each division manner corresponds to one rendering style, and style information may be configured for each division manner. For each division manner, after the to-be-rendered image is divided into different regions in the division manner, different regions may be placed in different texture partitions, and a texture abscissa and a texture ordinate of each pixel on the to-be-rendered image in the division manner may be obtained. The texture abscissa and the texture ordinate of each pixel in the division manner may be used as texture coordinate data. Style information corresponding to the division manner and the texture coordinate data may be stored as a group of gradient data. A plurality of groups of gradient data may be obtained in a case of various division manners.

In some embodiments, the terminal may read style information in each group of locally-stored gradient data, compare the style information of the target rendering style with the style information in each group of gradient data, obtain, when the style information of the target rendering style is consistent with the style information in each group of gradient data, texture coordinate data in gradient data to which corresponding style information belongs, and use the texture coordinate data as the texture coordinate data matched with the style information of the target rendering style.

In some embodiments, after obtaining the texture coordinate data matched with the style information of the target rendering style, the terminal may use the texture abscissa of each pixel in the texture coordinate data as the first position information of each pixel under the target rendering style.

In the embodiment, after the style information of the target rendering style is obtained, the first position information of each pixel on the target object may be determined based on the style information, and then the image of the target object under the target rendering style may be generated based on the first position information. This manner provides a selection entry of a rendering style for the user, such that the user may select a most appropriate rendering style from a plurality of rendering styles. Thus, personalized design experience for the target object is improved.

In some embodiments, the operation of determining, according to the first position information of each pixel under the target rendering style, the target texture partition to which each pixel belongs includes the following operations: obtain a position range corresponding to each texture partition under the target rendering style; and match the first position information of each pixel on the target object with each position range, and determine, based on a matching result, a target texture partition to which the pixel belongs.

The two-dimensional image editing interface in the software for making a model includes the texture abscissa axis and the texture ordinate axis. The two-dimensional image editing interface may be divided into a plurality of regions according to the preset rule, and each region may be referred to as the texture partition.

For example, in the two-dimensional image editing interface, a range of the texture abscissa axis is (−1, 2). A region whose texture abscissa is (−1, 0) may be used as a texture partition, a region whose texture abscissa is (0, 1) may be used as another texture partition, and a region whose texture abscissa is (1, 2) may be used as yet another texture partition. Thus, 3 texture partitions are obtained.

It is to be noted that a texture partition is divided according to −1<texture abscissa <0, 0<texture abscissa <1, and 1<texture abscissa <2, which is merely an example. Other division manners or may be used. A quantity of texture partitions is not limited to 3, may be less than 3, or greater than 3, and is not limited in the embodiment of this application.

The terminal may obtain the position range corresponding to each texture partition on the two-dimensional image editing interface, and determine a target texture partition to which each pixel on the to-be-rendered image belongs through the position range. For example, when a texture partition is divided according to −1<texture abscissa <0, 0<texture abscissa <1, and 1<texture abscissa <2, a position range of the texture partition corresponding to −1<texture abscissa <0 is u^{∈} (−1, 0), a position range of the texture partition corresponding to 0<texture abscissa <1 is u^{∈} (0, 1), and a position range of the texture partition corresponding to 1<texture abscissa <2 is u^{∈} (1, 2), where u represents the texture abscissa.

After the terminal obtains the first position information of each pixel on the target object, the first position information of each pixel is matched with the position range corresponding to each texture partition, and the texture partition corresponding to the successfully matched position range is used as the target texture partition to which the pixel belongs.

In specific implementation, after the texture abscissa of each pixel is obtained from the texture coordinate data, the texture abscissa of each pixel may be compared with the position range corresponding to each texture partition, the position range within which the texture abscissa falls may be determined, and the position range may be used as the target texture partition to which the pixel belongs.

For example, assuming that there are 3 texture partitions, which include a texture partition 1, a texture partition 2, and a texture partition 3, a position range corresponding to the texture partition 1 is u^{∈} (−1, 0), a position range corresponding to the texture partition 2 is u^{∈} (0, 1), and a position range corresponding to the texture partition 3 is u^{∈} (1, 2), where u represents the texture abscissa. Assuming that a texture coordinate of a pixel on the target object is (1.5, 2), a texture abscissa 1.5 of the pixel is in (1, 2), such that the texture partition 3 is a target texture partition to which the pixel belongs.

In the embodiment, a target texture partition of each pixel on the target object may be determined by matching a texture abscissa of the pixel with a position range of each texture partition, then a color of the pixel may be computed based on the target texture partition, and finally, the image corresponding to the target object may be generated based on the color of each pixel on the target object. The image generated in this manner corresponds to the target rendering style, and different rendering styles correspond to different image presentation effects, such that the user may select a rendering style according to a preference of the user, and a personalized design requirement of the user is satisfied.

In some embodiments, the operation of determining the color of each pixel on the target object according to the color configuration information of the target texture partition, the color change information of the target texture partition, and the second position information of each pixel on the target object under the target rendering style includes the following operations: determine, according to color configuration information of a target texture partition to which each pixel on the target object belongs, a main partition color and a secondary partition color of the target texture partition; determine a first pixel value according to the main partition color, second position information of the pixel under the target rendering style, and color change information of the target texture partition to which the pixel belongs; determine a second pixel value according to the secondary partition color, the second position information of the pixel under the target rendering style, and the color change information of the target texture partition to which the pixel belongs; and determine a color of the pixel based on the first pixel value and the second pixel value.

The color configuration information of the target texture partition includes the hue combination information and the color attribute information of each color in the hue combination information. The color attribute information of each color includes the main and secondary attributes, the value and the saturation of the color.

The terminal may extract the color attribute information of each color from the color configuration information of the target texture partition, extract the main and secondary attributes from the color attribute information of each color, and determine the main partition color and the secondary partition color of the target texture partition based on the main and secondary attributes of each color.

The color change information of the target texture partition includes a gradient position and a gradient range. Second position information of a pixel under the target rendering style may be a texture ordinate of the pixel.

In specific implementation, the terminal may use a color whose main and secondary attributes indicate a main color in the hue combination information as the main partition color, and may use a color whose main and secondary attributes indicate a secondary color in the hue combination information as the secondary partition color. The terminal may extract value and saturation of the main partition color, determine a color value of the main partition color based on the value and the saturation of the main partition color, and determine the first pixel value based on the color value of the main partition color, the second position information of the pixel under the target rendering style, and the color change information of the target texture partition to which the pixel belongs.

Similarly, the terminal may extract value and saturation of the secondary partition color, determine a color value of the secondary partition color based on the value and the saturation of the secondary partition color, and determine the second pixel value based on the color value of the secondary partition color, the second position information of the pixel under the target rendering style and the color change information of the target texture partition to which the pixel belongs.

After obtaining the first pixel value and the second pixel value, the terminal may add the first pixel value and the second pixel value, such that the color of the corresponding pixel may be obtained.

In specific implementation, a first pixel value of each pixel on the target object may be computed through the following formula: color value of main partition color×(1-(texture ordinate-gradient position)×gradient range). A second pixel value of the pixel may be computed through the following formula: color value of secondary partition color×(texture ordinate-gradient position)×gradient range.

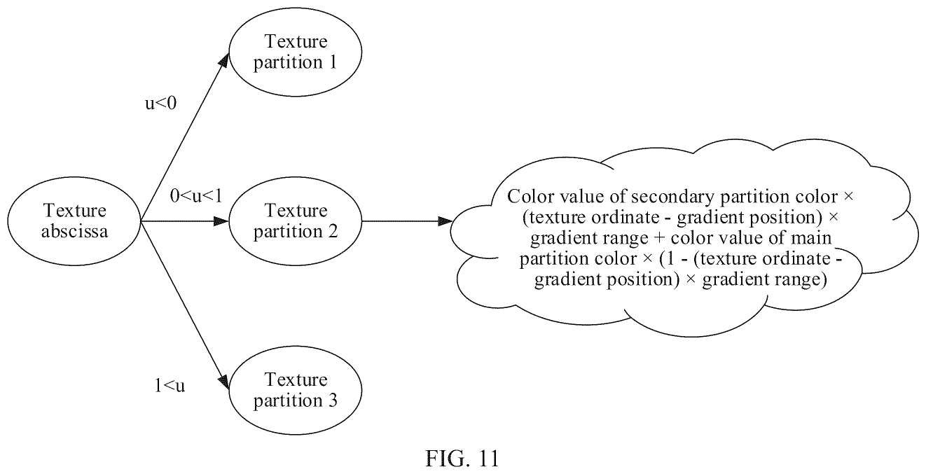

For example, with reference to FIG. 11, a texture abscissa of each pixel on the target object may be matched with a position range corresponding to each texture partition, such that a target texture partition to which the pixel belongs is determined. The color value of the main partition color and the color value of the secondary partition color may be determined based on the color configuration information of the target texture partition, and then a color of the pixel may be computed through the following formula: color value of secondary partition color×(texture ordinate-gradient position)×gradient range+color value of main partition color×(1−(texture ordinate−gradient position)× gradient range).

In the embodiment, a specific manner of determining the color of each pixel on the target object according to the color configuration information of the target texture partition, the color change information of the target texture partition, and the second position information of each pixel on the target object under the target rendering style is provided. Then, the color of each pixel on the target object may be mapped to the region on the display screen, such that the image corresponding to the target object is generated. The image generated in this manner corresponds to the target rendering style, and different rendering styles correspond to different image presentation effects, such that a personalized design requirement of the user is satisfied.

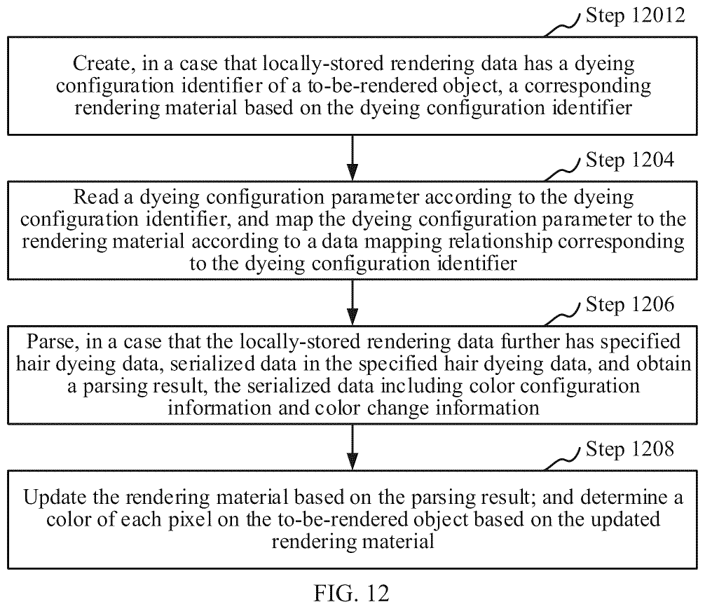

In some embodiments, with reference to FIG. 12, the operation of determining the color of each pixel on the target object according to the color configuration information of the target texture partition, the color change information of the target texture partition, and the second position information of each pixel on the target object under the target rendering style includes the following operations:

Operation 1202: Create, when locally-stored rendering data has a dyeing configuration identifier of the target object, a corresponding rendering material based on the dyeing configuration identifier.

Operation 1204: Read a dyeing configuration parameter according to the dyeing configuration identifier, and map the dyeing configuration parameter to the rendering material according to a data mapping relationship corresponding to the dyeing configuration identifier.

Operation 1206: Parse, when the locally-stored rendering data further has specified hair dyeing data, serialized data in the specified hair dyeing data, and obtain a parsing result, the serialized data including color configuration information and color change information.

Operation 1208: Update the rendering material based on the parsing result; and determine the color of each pixel on the target object based on the updated rendering material.

The rendering data includes an identifier of the target object, the dyeing configuration identifier of the target object, or the specified hair dyeing data. The specified hair dyeing data may include a user-defined hair dyeing identifier and user-defined configuration data.

After obtaining the color configuration information and the color change information of each texture partition under the target rendering style, the terminal may conduct serialization on the style information of the target rendering style, the color configuration information, and the color change information, so as to obtain the serialized data. The serialized data may be used as the user-defined configuration data.

With the target object as the hair style as an example, in the development stage, the plotter may draw various hair styles and configure a unique identifier for each hair style. After drawing is completed, each hair style may be divided in different division manners. For each division manner, after the hair style is divided into a plurality of regions in the division manner, the plurality of regions may be placed in different texture partitions, and a texture abscissa and a texture ordinate of each pixel on the hair style in the division manner may be obtained. The texture abscissa and the texture ordinate may be used as the texture coordinate data. The terminal may store the identifier of the hair style, style information corresponding to the division manner and the texture coordinate data as a group of gradient data.

The terminal may read locally-stored rendering data, extract the identifier of the target object from the rendering data, and seek, based on the extracted identifier of the target object, gradient data matched with the identifier from the stored gradient data. The terminal may parse the serialized data to obtain style information in the serialized data, seek the texture coordinate data corresponding to the target object and matched with the style information from the sought gradient data, and further determine, from the texture coordinate data, the first position information and the second position information corresponding to each pixel on the target object.

The terminal may determine whether the dyeing configuration identifier of the target object exists in the rendering data. If the dyeing configuration identifier of the target object exists in the rendering data, the rendering material that needs to be created by the dyeing configuration identifier is sought in a preset mapping relationship, and a corresponding rendering material is created based on a seeking result. If the dyeing configuration identifier of the target object does not exist in the rendering data, the target object is not processed.

After creating the rendering material, the terminal may read the dyeing configuration parameter according to the dyeing configuration identifier, and map the dyeing configuration parameter to the rendering material according to the data mapping relationship corresponding to the dyeing configuration identifier, so as to obtain a target rendering material.

The dyeing configuration parameter includes default color configuration information, default color change information, etc. The parameters may be mapped to the rendering material, and the target rendering material may be obtained. A quantity of the rendering materials may be one or greater than one, and is not limited in the embodiment of this application.

The terminal may further determine whether the specified hair dyeing data exists in the rendering data, extract the user-defined hair dyeing identifier from the specified hair dyeing data in a case with the specified hair dyeing data, obtain a data parsing table of serialized data in the specified hair dyeing data based on the user-defined hair dyeing identifier, and parse the serialized data in the specified hair dyeing data based on the parsing table, so as to obtain the parsing result. In a case without the specified hair dyeing data, the terminal determines the color of each pixel on the target object based on the target rendering material.

After obtaining the parsing result, the terminal may update the rendering material based on the parsing result. The terminal may determine the color of each pixel on the target object based on the updated rendering material.

The updated rendering material includes color configuration information and color change information of a target texture partition to which each pixel belongs. The color of each pixel on the target object may be determined based on the color configuration information, the color change information, and a texture ordinate of the pixel under the target rendering style. The updated rendering material may further include other parameters. After determining an initial color of a pixel based on the color configuration information, the color change information, and a texture ordinate of the pixel under the target rendering style, the terminal may further optimize the initial color through a corresponding formula based on other parameters, so as to obtain a final color of the pixel.

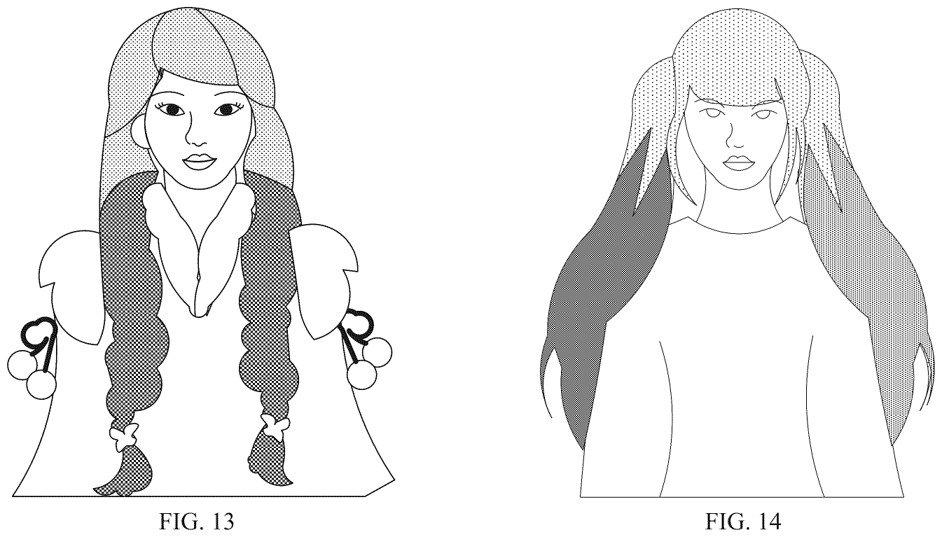

For example, FIG. 13 is a schematic diagram of an image corresponding to a target object generated by the terminal when a user specifies vertical gradient change. FIG. 14 is a schematic diagram of an image corresponding to a target object generated by the terminal when a user specifies lateral gradient change.

In the embodiment, the rendering material may be created based on the rendering data, the corresponding dyeing configuration parameter may be added to the rendering material, and the color of each pixel on the target object may be determined based on the obtained rendering material.

In some embodiments, the operations of parsing the serialized data in the specified hair dyeing data, and obtaining the parsing result include the following operations: obtain a data parsing table of the serialized data in the specified hair dyeing data, the data parsing table including occupied space sizes of different parameters in the serialized data; and split the serialized data according to the occupied space sizes of the different parameters, obtain a parameter included in the serialized data, and use the parameter included in the serialized data as the parsing result.

The data parsing table may include information such as a parameter identifier, a parameter type, an occupied space size, and a conversion mode of each parameter. The terminal may extract the serialized data from the specified hair dyeing data, and clip, based on an occupied space size of a first parameter in the data parsing table, previous data of a corresponding quantity of bits from the serialized data as a value of the first parameter. Data of a corresponding quantity of bits is clipped from remaining clipped data based on an occupied space size of a second parameter in the data parsing table as a value of the second parameter. The rest can be done in the same manner until there is no remaining data. The clipped data may be used as a parameter included in the serialized data, and the parameter included in the serialized data may be used as the parsing result.

For example, assuming that values of a hue (H), saturation(S), and value (V) that are set by the user are: 0xAA, 0xBB, and 0xCC, a gradient position set by the user is: 0x32. Serialization is conducted on the data, such that serialized data is obtained as 0x AABBCC32, where 0x is a hexadecimal symbol. Assuming that a data parsing table of serialized data in specified hair dyeing data is shown in Table 1:

TABLE 1

| id | Type | Occupied size | Conversion mode |
|---|---|---|---|
| p1 | Color | 3byte | hsv |
| p2 | Gradient position | 1byte | — |

It may be seen based on the parsing table shown in Table 1 that if a type of a first parameter in the serialized data is a color and an occupied space size of the parameter is 3 byte, first 6 bits of data in AABBCC32 are clipped to obtain AABBCC, and the AABBCC may be used as a value of the first parameter. It may be seen based on the parsing table in Table 1 that if a conversion mode of the first parameter is hsv, it may be further determined that a hue is AAA, saturation is BB, and value is CC. It may be seen based on the parsing table shown in Table 1 that if a type of a second parameter in the serialized data is a gradient position and an occupied space size of the parameter is 1 byte, two bits of data remain in the serialized data through a clipping operation corresponding to the first parameter, and the two bits of data (32) may be used as a value of the second parameter. It may be seen based on the parsing table in Table 2 that if a type of the second parameter is a gradient position, the gradient position may be determined as 32.

In the embodiment, serialization is conducted on the color configuration information and the color change information, such that occupied storage space may be reduced, and network communication between the terminal, the server, and another terminal may be facilitated. If the serialized data is not parsed through a corresponding parsing table, a correct display effect fails to be obtained. Thus, security may be improved, cost of third-party attacks and tampering in a network communication process may be increased, and a possibility of attacking and tampering is reduced.

In some embodiments, the operation of updating the parameter in the rendering material based on the parsing result includes the following operations: seek a material identifier corresponding to each parameter in the parsing result from the data mapping relationship; and update, based on the parameter, the rendering material corresponding to the material identifier.

The dyeing configuration parameter includes the default color configuration information, the default color change information, etc. Different rendering materials may include part or all of the parameters. After the serialized data in the specified hair dyeing data is parsed to obtain the parsing result, the material identifier corresponding to each parameter included in the parsing result may be sought in the data mapping relationship. A parameter value in the rendering material corresponding to the material identifier is updated to a value in the parsing result.

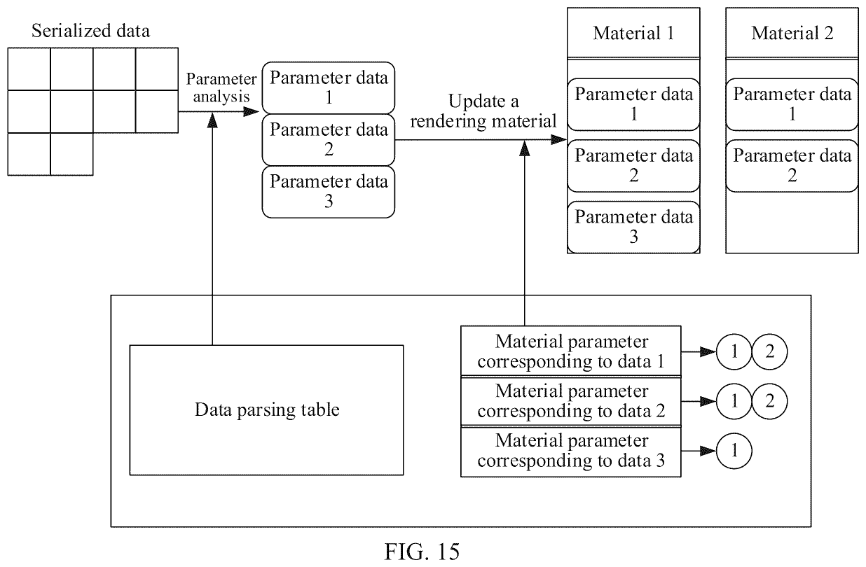

For example, as shown in FIG. 15, parameter parsing may be conducted on the serialized data according to the data parsing table, and parameter data 1, parameter data 2 and parameter data 3 may be obtained. According to the data mapping relationship, it may be seen that if the parameter data 1 corresponds to a material 1 and a material 2, the parameter data 2 corresponds to the material 1 and the material 2, and the parameter data 3 corresponds to the material 1, the parameter data 1, the parameter data 2 and the parameter data 3 may be updated to the material 1, the parameter data 1 and the parameter data 2 may be updated to the material 2, and an updated material 1 and an updated material 2 may be obtained.

After obtaining the updated rendering material, the terminal may conduct optimization on the color of each pixel based on the updated rendering material, and generate the image corresponding to the target object based on the optimized color corresponding to each pixel.

In the embodiment, after the serialized data is parsed to obtain the parsing result, the parameter value in the rendering material is updated based on the parsing result. Thus, the updated rendering material is obtained. The rendering material may be used for conducting optimization on the color of each pixel on the target object, such that the finally generated image is more vivid and realistic, and an image presentation effect is improved.

In some embodiments, the method for processing an image according to the embodiment of this application further includes operations: determine a random gray value of each component of the target object; and obtain a target component in a preset gray-scale range, and update a pixel included in the target component to a preset color.

The target object may be a hair style, clothing, etc. of a virtual character. When the target object is the hair style of the virtual character, each component of the target object may be a hair included in the hair style of the virtual character.

The terminal may randomly allocate a gray value to each component of the target object, and may use the gray value as a random gray value of a corresponding component. In this way, each component on the target object has a corresponding random gray value.

The terminal may match the gray value of each component with a preset gray-scale range. If the gray value of the component falls within the preset gray-scale range, the component is used as the target component. The terminal may further update a pixel included in each target component to the preset color. The preset color may be specified by the user, or specified by default, and is not limited in the embodiment of this application.

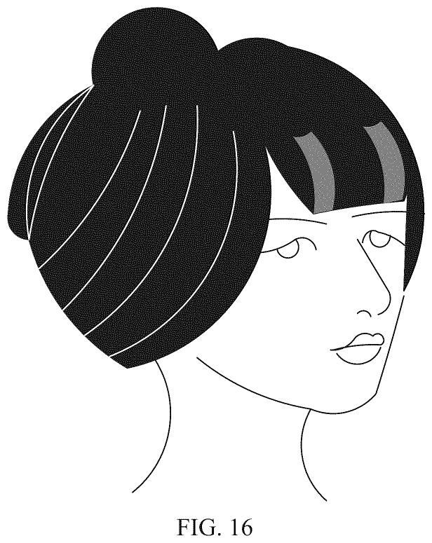

In specific implementation, the method for processing an image according to the embodiment of this application may be applied to a game APP, the target object may be the hair style of the virtual character, and each component of the target object may be a hair included in the hair style of the virtual character. The user may log in to the game APP through an account, and opens a setting page of hair of the virtual character on the game APP. The setting page of the hair of the virtual character is configured with a highlighting control. The user may click on the highlighting control. In response to a clicking operation, the game APP may randomly allocate a gray value to each hair included in the hair style of the virtual character corresponding to the account used during login, and may use the gray value as a random gray value of the hair. The game APP may match a gray value of each hair with the preset gray-scale range. If the gray value of the hair falls within the preset gray-scale range, the hair is used as a target hair. The terminal may update a pixel included in the target hair to the preset color, such that highlighting of the hair style of the virtual character is implemented. For example, FIG. 16 is a schematic diagram of an image of a target object generated by the terminal after the user clicks on the highlighting control.

In the embodiment, the random gray value of each component of the target object is determined first. Then, the target component in the preset gray-scale range is obtained, and the pixel included in the target component is updated to the preset color, such that highlighting of the target object is implemented, and diversity of an image presentation effect is improved.

In some embodiments, the method for processing an image according to the embodiment of this application further includes the following operations: conduct serialization on the style information, the color configuration information, and the color change information, and obtain the serialized data; and transmit the serialized data to a server in response to a data synchronization request, so as to instruct the server to synchronize the serialized data to a target terminal, the target terminal having an association relationship with a terminal corresponding to the target object.

The terminal may conduct serialization on the style information, the color configuration information, and the color change information, and obtain the serialized data. When the user is satisfied with the image presentation effect corresponding to the target object, the data synchronization request may be triggered. The terminal may transmit the serialized data to the server in response to the data synchronization request.

The data synchronization request carries an account corresponding to the target object. After receiving the data synchronization request, the server may obtain, based on the account, an account having an interactive relationship with the account, use a terminal corresponding to the account as a target terminal, and transmit the serialized data to the target terminal. When displaying the target object, the target terminal generates a corresponding image according to the serialized data, such that a presentation effect of the target object is synchronized on all the terminals.

An account having an interactive relationship with an account may be an account having a friend relationship with the account, or may be an account that participates in a three-dimensional competitive game together with the account.

In specific implementation, the method for processing an image according to the embodiment of this application may be applied to a game APP. The target object may be a hair style of a virtual character. When the user is satisfied with a presentation effect of the hair style of the virtual character, the game APP may trigger the data synchronization request. The terminal transmits an account used during login and the serialized data to the server. The server seeks, based on the account, an account having an interactive relationship with the account, and transmits the serialized data to the terminal corresponding to the account, such that a hair style effect presented by the terminal is consistent.

In the embodiment, in response to determining that the generated image corresponding to the target object satisfies a requirement, the user may trigger the data synchronization request. The server may synchronize the serialized data to another terminal having an interactive relationship, such that a presentation effect of the target object is synchronized on each terminal.

In some embodiments, the method for processing an image according to the embodiment of this application may be applied to a game scene. The target object is a hair style of a virtual character. The target rendering style is a gradient hair style specified for the hair style of the virtual character. The color configuration information includes at least one of a hue, value, or saturation. The color change information includes at least one of a gradient position and a gradient range.

The terminal is configured with a game APP corresponding to the game scene. The user may specify a rendering style for the hair style of the virtual character on the game APP, specify hue combination information of each texture partition for the texture partition under the rendering style, specify main and secondary attributes, value and saturation for each color in the hue combination information, and may further specify a gradient position and a gradient range of the texture partition. The terminal may determine, based on the style information of the rendering style specified by the user, the texture abscissa of each pixel on the hair style of the virtual character under the rendering style, and determine, according to the texture abscissa of each pixel under the rendering style, the target texture partition to which each pixel belongs. The color of each pixel on the hair style of the virtual character may be determined according to the hue combination information of the target texture partition, the main and secondary attributes, the value and the saturation of each color in the hue combination information, the gradient position and the gradient range of the target texture partition, and the texture ordinate of each pixel on the hair style of the virtual character under the rendering style. The image corresponding to the hair style of the virtual character may be generated based on the color of each pixel on the hair style of the virtual character for the user to view.

In the embodiment, a specific implementation process of applying the method for processing an image according to the embodiment of this application to a game scene is provided. This manner enables a game player to freely set a hair dyeing style of the hair style of the virtual character, thus improving personalized play experience.

It is to be noted that the application scene provided above is merely used for describing the method for processing an image of this application, and application of the method for processing an image according to this application is not limited to the application scene provided above. For example, the method or may be applied to an image editing scene or a photographing scene, which is not limited in the embodiment of this application.

In some embodiments, a method for processing an image is provided. With a case that the method is applied to a terminal as an example, description is provided. The method includes the following operations:
use, in response to a rendering style specifying operation, a specified rendering style corresponding to the rendering style specifying operation as a target rendering style, and use style information of the specified rendering style as style information of the target rendering style; obtain hue combination information of each texture partition under the target rendering style through a hue combination configuration region; determine, based on an attribute adjustment control of each color in the hue combination information included in a color attribute configuration region, color attribute information of each color included in the hue combination information; determine, based on the hue combination information and the color attribute information, color configuration information of each texture partition under the target rendering style; determine, based on a color change control of each texture partition under the target rendering style included in a color change configuration region, color change information of each texture partition under the target rendering style;
seek, according to the style information, texture coordinate data corresponding to a target object and matched with the style information; seek a texture abscissa of each pixel on the target object from the texture coordinate data, and use the texture abscissa of each pixel as first position information of a corresponding pixel under the target rendering style;
obtain a position range corresponding to each texture partition under the target rendering style; match the first position information of each pixel on the target object with each position range, and determine, based on a matching result, a target texture partition to which the pixel belongs;
determine, according to color configuration information of a target texture partition to which each pixel on the target object belongs, a main partition color and a secondary partition color of the target texture partition; determine a first pixel value according to the main partition color, second position information of the pixel under the target rendering style, and color change information of the target texture partition to which the pixel belongs; determine a second pixel value according to the secondary partition color, the second position information of the pixel under the target rendering style, and the color change information of the target texture partition to which the pixel belongs; determine a color of the pixel based on the first pixel value and the second pixel value; and
map the color of each pixel on the target object to a region on a display screen, and generate an image corresponding to the target object.

In the embodiment, the target rendering style is determined, the style information of the target rendering style, and the color configuration information and the color change information of each texture partition under the target rendering style are obtained, and according to the style information, the first position information of each pixel on the target object under the target rendering style is determined; according to the first position information of each pixel under the target rendering style, the target texture partition to which each pixel belongs is determined; the color of each pixel on the target object is determined according to the color configuration information of the target texture partition, the color change information of the target texture partition, and the second position information of each pixel on the target object under the target rendering style; and the color of each pixel on the target object is mapped to the region on the display screen, and the image corresponding to the target object is generated. The image of the generated target object corresponds to the target rendering style, and different rendering styles correspond to different image presentation effects. This manner provides a selection entry of a rendering style for a user, such that the user may select a most appropriate rendering style from a plurality of rendering styles. Thus, personalized design experience of the user for the target object is improved, and a problem of low dyeing efficiency caused by repeated dyeing adjustment in a case of a monotonous dyeing function is solved.

It is to be understood that, although all the operations are displayed sequentially according to instructions of arrows in the flowcharts of all the embodiments, the operations are not necessarily executed sequentially in an order indicated by the arrows. Unless otherwise explicitly specified herein, an execution order of the operations is not strictly limited, and the operations may be executed in other orders. Moreover, at least some operations in the flowchart involved in each embodiment may include a plurality of operations or a plurality of stages. The operations or stages are not necessarily executed completely at the same moment and may be executed at different moments. The operations or stages are not necessarily sequentially executed, and may be executed alternately with other operations or at least some operations or stages of other operations.

Based on a same inventive concept, an embodiment of this application further provides an apparatus for processing an image, which is configured to implement the above method for processing an image. The implementation solution to the problem provided by the apparatus is similar to that described in the method, so reference may be made to limitations to the above method for processing an image for specific limitations to embodiments of one or more apparatuses for processing an image provided below, which will not be repeated herein.

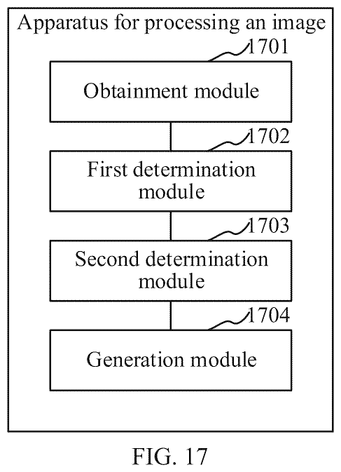

In an embodiment, as shown in FIG. 17, an apparatus for processing an image is provided and includes:
an obtainment module 1701 configured to determine a target rendering style, and obtain style information of the target rendering style, and color configuration information and color change information of each texture partition under the target rendering style;
a first determination module 1702 configured to determine, according to the style information, first position information of each pixel on a target object under the target rendering style; and determine, according to the first position information of each pixel under the target rendering style, a target texture partition to which each pixel belongs;
a second determination module 1703 configured to determine a color of each pixel on the target object according to color configuration information of the target texture partition, color change information of the target texture partition, and second position information of each pixel on the target object under the target rendering style; and
a generation module 1704 configured to map the color of each pixel on the target object to a region on a display screen, and generate an image corresponding to the target object.

In some embodiments, the obtainment module 1701 is specifically configured to use, in response to a rendering style specifying operation, a specified rendering style corresponding to the rendering style specifying operation as the target rendering style, and use style information of the specified rendering style as the style information of the target rendering style; and display a rendering configuration region corresponding to the target rendering style, and obtain the color configuration information and the color change information of each texture partition under the target rendering style through the rendering configuration region.

In some embodiments, the rendering configuration region includes a hue combination configuration region, a color change configuration region, and a color attribute configuration region. The obtainment module 1701 is specifically configured to obtain hue combination information of each texture partition under the target rendering style through the hue combination configuration region; obtain color attribute information of each color included in the hue combination information through the color attribute configuration region; determine, based on the hue combination information and the color attribute information, the color configuration information of each texture partition under the target rendering style; and obtain the color change information of each texture partition under the target rendering style through the color change configuration region.

In some embodiments, the color attribute configuration region includes an attribute adjustment control of each color in the hue combination information. The obtainment module 1701 is specifically configured to determine, based on a touch operation on the attribute adjustment control, the color attribute information of each color included in the hue combination information.

In some embodiments, the color change configuration region includes a color change control of each texture partition under the target rendering style. The obtainment module 1701 is specifically configured to determine, based on a touch operation on the color change control, the color change information of each texture partition under the target rendering style.

In some embodiments, the first determination module 1702 is specifically configured to seek, according to the style information, texture coordinate data corresponding to the target object and matched with the style information; and seek a texture abscissa of each pixel on the target object from the texture coordinate data, and use the texture abscissa of each pixel as first position information of a corresponding pixel under the target rendering style.

In some embodiments, the first determination module 1702 is specifically configured to obtain a position range corresponding to each texture partition under the target rendering style; and match the first position information of each pixel on the target object with each position range, and determine, based on a matching result, a target texture partition to which the pixel belongs.

In some embodiments, the second determination module 1703 is specifically configured to determine, according to color configuration information of a target texture partition to which each pixel on the target object belongs, a main partition color and a secondary partition color of the target texture partition; determine a first pixel value according to the main partition color, second position information of the pixel under the target rendering style, and color change information of the target texture partition to which the pixel belongs; determine a second pixel value according to the secondary partition color, the second position information of the pixel under the target rendering style, and the color change information of the target texture partition to which the pixel belongs; and determine a color of the pixel based on the first pixel value and the second pixel value.

In some embodiments, the generation module 1704 is specifically configured to create, when locally-stored rendering data has a dyeing configuration identifier of the target object, a corresponding rendering material based on the dyeing configuration identifier; read a dyeing configuration parameter according to the dyeing configuration identifier, and map the dyeing configuration parameter to the rendering material according to a data mapping relationship corresponding to the dyeing configuration identifier; parse, when the locally-stored rendering data further has specified hair dyeing data, serialized data in the specified hair dyeing data, and obtain a parsing result, the serialized data including the color configuration information and the color change information; update the rendering material based on the parsing result; and determine the color of each pixel on the target object based on the updated rendering material.

In some embodiments, the generation module 1704 is further configured to obtain a data parsing table of the serialized data in the specified hair dyeing data, the data parsing table including occupied space sizes of different parameters in the serialized data; and split the serialized data according to the occupied space sizes of the different parameters, obtain a parameter included in the serialized data, and use the parameter included in the serialized data as the parsing result.

In some embodiments, the generation module 1704 is further configured to seek a material identifier corresponding to each parameter in the parsing result from the data mapping relationship; and update, based on the parameter, the rendering material corresponding to the material identifier.

In some embodiments, the generation module 1704 is further configured to determine a random gray value of each component of the target object; and obtain a target component in a preset gray-scale range based on the random gray value, and update a pixel included in the target component to a preset color.

In some embodiments, the generation module 1704 is further configured to conduct serialization on the style information, the color configuration information, and the color change information, and obtain the serialized data; and transmit the serialized data to a server in response to a data synchronization request, so as to instruct the server to synchronize the serialized data to a target terminal, the target terminal having an association relationship with a terminal corresponding to the target object.

In some embodiments, the target object is a hair style of a virtual character. The target rendering style is a gradient hair style specified for the hair style of the virtual character. The color configuration information includes at least one of a hue, value, or saturation. The color change information includes at least one of a gradient position and a gradient range.

All the modules in the apparatus for processing an image may be partially or completely implemented through software, hardware, or any combination thereof. All the modules may be embedded in or independent of a processor in a computer device in a form of hardware, or may be stored in a memory in a computer device in a form of software, such that the processor may invoke and execute operations corresponding to the modules.

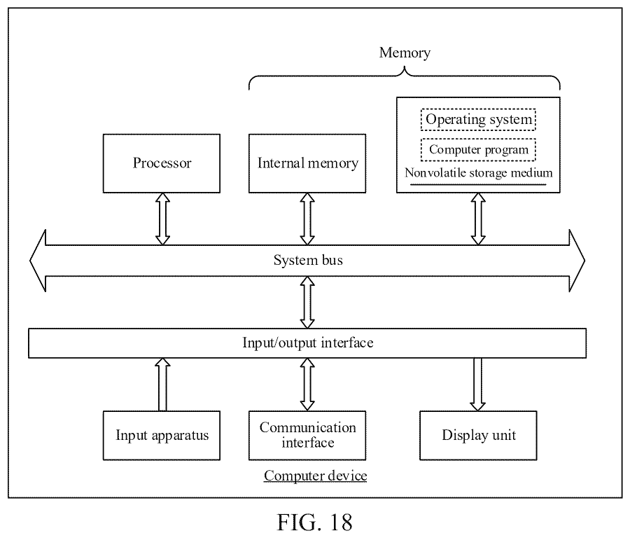

An embodiment provides a computer device. The computer device may be a terminal. An internal structural diagram of the computer device may be shown in FIG. 18. The computer device includes a processor, a memory, an input/output interface, a communication interface, a display unit, and an input apparatus. The processor, the memory and the input/output interface are connected through a system bus. The communication interface, the display unit and the input apparatus are connected to the system bus through the input/output interface. The processor of the computer device is configured to provide computing and control abilities. The memory of the computer device includes a nonvolatile storage medium and an internal memory. The nonvolatile storage medium stores an operating system and a computer program. The internal memory provides an environment for running of the operating system and the computer program in the nonvolatile storage medium. The input/output interface of the computer device is configured to exchange information between the processor and an external device. The communication interface of the computer device is configured to conduct wired or wireless communication with an external terminal. The wireless communication may be implemented through wireless fidelity (WIFI), a mobile cellular network, near field communication (NFC), or another technology. The computer program implements the method for processing an image when being executed by the processor. The display unit of the computer device is configured to form a visually visible picture, and may be a display screen, a projection apparatus, or a virtual reality imaging apparatus. The display screen may be a liquid crystal display screen or an electronic-ink display screen. The input apparatus of the computer device may be a touch layer covering the display screen, or may be a key, a trackball, or a touchpad arranged on a housing of the computer device, or may be an external keyboard, touchpad, mouse, etc.

It may be understood by those skilled in the art that a structure shown in FIG. 18 is merely a block diagram of part of a structure related to a solution of this application, and does not constitute a limitation to the computer device to which the solution of this application is applied. Specific computer devices may include more or less components than those shown in the figure, or some components may be combined, or different component arrangements are provided.

An embodiment further provides a computer device. The computer device includes a memory and a processor. The memory stores a computer program. The processor implements the operations of each method embodiment when executing the computer program.

An embodiment provides a computer-readable storage medium. The computer-readable storage medium has a computer program stored therein. The computer program implements the operations of each method embodiment when being executed by a processor.

An embodiment provides a computer program product. The computer program product includes a computer program. The computer program implements the operations of each method embodiment when being executed by a processor.

It is to be noted that user information (including, but not limited to, a user account, user personal information, etc.) and data (including, but not limited to, data for analysis, data for storage, data for display, etc.) involved in this application are all information and data permitted by a user or fully permitted by all parties, and The collection, use and processing of relevant data have to comply with relevant laws, regulations and standards of relevant countries and regions.

Those of ordinary skill in the art may understand that all or some flows in the method of the embodiments may be implemented by enabling a computer program to instruct relevant hardware. The computer program may be stored in one nonvolatile computer-readable storage medium. When the computer program is executed, flows of all the embodiments of the method may be implemented. Any reference to a memory, a database or other media used in all the embodiments provided by this application may include at least one of a nonvolatile memory and a volatile memory. The nonvolatile memory may include a read-only memory (ROM), a magnetic tape, a floppy disk, a flash memory, an optical memory, a high-density embedded nonvolatile memory, a resistive random access memory (ReRAM), a magnetoresistive random access memory (MRAM), a ferroelectric random access memory (FRAM), a phase change memory (PCM), a graphene memory, etc. The volatile memory may include a random access memory (RAM) or an external cache memory. For the purpose of illustration rather than limitation, the RAM may be in various forms, such as a static random access memory (SRAM), or a dynamic random access memory (DRAM). The database involved in all the embodiments provided by this application may include at least one of a relational database and a non-relational database. The non-relational database may include, but is not limited to, a distributed database based on blockchain, etc. The processor involved in all the embodiments provided by this application may be, but is not limited to, a general-purpose processor, a central processing unit, a graphics processing unit, a digital signal processor, a programmable logic, a data processing logic based on quantum computing, etc.

All technical features of the embodiments may be arbitrarily combined. To simplify description, all possible combinations of all the technical features of the embodiments are not described. However, if only the combinations of these technical features do not conflict, they are to be considered to be within the scope of the description.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules. Moreover, each module or unit can be part of an overall module or unit that includes the functionalities of the module or unit. The embodiments mentioned above are merely several implementations of this application, and are specifically described in detail, but cannot be interpreted as limiting the scope of the patent for the disclosure as a result. It is to be noted that for those of ordinary skill in the art, they may make several transformations and improvements without deviating from a concept of this application, and these transformations and improvements all fall within the protection scope of this application. Hence, the scope of protection of the patent of this application is to be subject to the appended claims.

What is claimed is:

1. A method for processing an image executed by a computer device, comprising:
obtaining a target rendering style, the target rendering style including style information, and color configuration information and color change information of each texture partition under the target rendering style;
determining, according to the style information, first position information of each pixel on a target object under the target rendering style;
determining, according to the first position information of each pixel under the target rendering style, a target texture partition to which the pixel belongs;
determining a color of each pixel on the target object according to color configuration information of the target texture partition, color change information of the target texture partition, and second position information of the pixel on the target object under the target rendering style; and
mapping the color of each pixel on the target object to a region on a display screen.

2. The method according to claim 1, wherein the obtaining a target rendering style comprise:
using a specified rendering style corresponding to the rendering style specifying operation as the target rendering style, and using style information of the specified rendering style as the style information of the target rendering style; and
displaying a rendering configuration region corresponding to the target rendering style, and obtaining the color configuration information and the color change information of each texture partition under the target rendering style through the rendering configuration region.

3. The method according to claim 1, wherein the determining, according to the style information, first position information of each pixel on a target object under the target rendering style comprises:
seeking, according to the style information, texture coordinate data corresponding to the target object and matched with the style information; and
seeking a texture abscissa of each pixel on the target object from the texture coordinate data, and using the texture abscissa of each pixel as first position information of a corresponding pixel under the target rendering style.

4. The method according to claim 1, wherein the determining, according to the first position information of each pixel under the target rendering style, a target texture partition to which the pixel belongs comprises:
obtaining a position range corresponding to each texture partition under the target rendering style; and
matching the first position information of the pixel on the target object with each position range to determine a target texture partition to which the pixel belongs.

5. The method according to claim 1, wherein the determining a color of each pixel on the target object according to color configuration information of the target texture partition, color change information of the target texture partition, and second position information of the pixel on the target object under the target rendering style comprises:
determining, according to color configuration information of a target texture partition to which the pixel on the target object belongs, a main partition color and a secondary partition color of the target texture partition;
determining a first pixel value according to the main partition color, second position information of the pixel under the target rendering style, and color change information of the target texture partition to which the pixel belongs;
determining a second pixel value according to the secondary partition color, the second position information of the pixel under the target rendering style, and the color change information of the target texture partition to which the pixel belongs; and
determining a color of the pixel based on the first pixel value and the second pixel value.

6. The method according to claim 1, wherein the determining a color of each pixel on the target object according to color configuration information of the target texture partition, color change information of the target texture partition, and second position information of the pixel on the target object under the target rendering style comprises:
creating, when locally-stored rendering data has a dyeing configuration identifier of the target object, a corresponding rendering material based on the dyeing configuration identifier;
reading a dyeing configuration parameter according to the dyeing configuration identifier, and mapping the dyeing configuration parameter to the rendering material according to a data mapping relationship corresponding to the dyeing configuration identifier;
parsing, when the locally-stored rendering data further has specified hair dyeing data, serialized data in the specified hair dyeing data, and obtaining a parsing result, the serialized data comprising the color configuration information and the color change information;
updating the rendering material based on the parsing result; and
determining the color of each pixel on the target object based on the updated rendering material.

7. The method according to claim 1, further comprising:
determining a random gray value of each component of the target object; and
obtaining a target component in a preset gray-scale range based on the random gray value, and updating a pixel comprised in the target component to a preset color.

8. The method according to claim 1, further comprising:
conducting serialization on the style information, the color configuration information, and the color change information to obtain serialized data; and
transmitting the serialized data to a server in response to a data synchronization request, wherein the server is configured to synchronize the serialized data to a target terminal, the target terminal having an association relationship with a terminal corresponding to the target object.

9. The method according to claim 1, wherein the target object is a hair style of a virtual character, the target rendering style is a gradient hair style specified for the hair style of the virtual character, the color configuration information comprises at least one of a hue, value, or saturation, and the color change information comprises at least one of a gradient position and a gradient range.

10. A computer device, comprising a memory and a processor, the memory storing a computer program that, when executed by the processor, causes the computer device to perform a method for processing an image including:
obtaining a target rendering style, the target rendering style including style information, and color configuration information and color change information of each texture partition under the target rendering style;
determining, according to the style information, first position information of each pixel on a target object under the target rendering style;
determining, according to the first position information of each pixel under the target rendering style, a target texture partition to which the pixel belongs;
determining a color of each pixel on the target object according to color configuration information of the target texture partition, color change information of the target texture partition, and second position information of the pixel on the target object under the target rendering style; and
mapping the color of each pixel on the target object to a region on a display screen.

11. The computer device according to claim 10, wherein the obtaining a target rendering style comprise:
using a specified rendering style corresponding to the rendering style specifying operation as the target rendering style, and using style information of the specified rendering style as the style information of the target rendering style; and
displaying a rendering configuration region corresponding to the target rendering style, and obtaining the color configuration information and the color change information of each texture partition under the target rendering style through the rendering configuration region.

12. The computer device according to claim 10, wherein the determining, according to the style information, first position information of each pixel on a target object under the target rendering style comprises:
seeking, according to the style information, texture coordinate data corresponding to the target object and matched with the style information; and
seeking a texture abscissa of each pixel on the target object from the texture coordinate data, and using the texture abscissa of each pixel as first position information of a corresponding pixel under the target rendering style.

13. The computer device according to claim 10, wherein the determining, according to the first position information of each pixel under the target rendering style, a target texture partition to which the pixel belongs comprises:
obtaining a position range corresponding to each texture partition under the target rendering style; and
matching the first position information of the pixel on the target object with each position range to determine a target texture partition to which the pixel belongs.

14. The computer device according to claim 10, wherein the determining a color of each pixel on the target object according to color configuration information of the target texture partition, color change information of the target texture partition, and second position information of the pixel on the target object under the target rendering style comprises:
determining, according to color configuration information of a target texture partition to which the pixel on the target object belongs, a main partition color and a secondary partition color of the target texture partition;
determining a first pixel value according to the main partition color, second position information of the pixel under the target rendering style, and color change information of the target texture partition to which the pixel belongs;
determining a second pixel value according to the secondary partition color, the second position information of the pixel under the target rendering style, and the color change information of the target texture partition to which the pixel belongs; and
determining a color of the pixel based on the first pixel value and the second pixel value.

15. The computer device according to claim 10, wherein the determining a color of each pixel on the target object according to color configuration information of the target texture partition, color change information of the target texture partition, and second position information of the pixel on the target object under the target rendering style comprises:
creating, when locally-stored rendering data has a dyeing configuration identifier of the target object, a corresponding rendering material based on the dyeing configuration identifier;
reading a dyeing configuration parameter according to the dyeing configuration identifier, and mapping the dyeing configuration parameter to the rendering material according to a data mapping relationship corresponding to the dyeing configuration identifier;
parsing, when the locally-stored rendering data further has specified hair dyeing data, serialized data in the specified hair dyeing data, and obtaining a parsing result, the serialized data comprising the color configuration information and the color change information;
updating the rendering material based on the parsing result; and
determining the color of each pixel on the target object based on the updated rendering material.

16. The computer device according to claim 10, wherein the method further comprises:
determining a random gray value of each component of the target object; and
obtaining a target component in a preset gray-scale range based on the random gray value, and updating a pixel comprised in the target component to a preset color.

17. The computer device according to claim 10, wherein the method further comprises:
conducting serialization on the style information, the color configuration information, and the color change information to obtain serialized data; and
transmitting the serialized data to a server in response to a data synchronization request, wherein the server is configured to synchronize the serialized data to a target terminal, the target terminal having an association relationship with a terminal corresponding to the target object.

18. The computer device according to claim 10, wherein the target object is a hair style of a virtual character, the target rendering style is a gradient hair style specified for the hair style of the virtual character, the color configuration information comprises at least one of a hue, value, or saturation, and the color change information comprises at least one of a gradient position and a gradient range.

19. A non-transitory computer-readable storage medium, having a computer program stored therein that, when being executed by a processor of a computer device, causes the computer device to perform a method for processing an image including:
obtaining a target rendering style, the target rendering style including style information, and color configuration information and color change information of each texture partition under the target rendering style;
determining, according to the style information, first position information of each pixel on a target object under the target rendering style;
determining, according to the first position information of each pixel under the target rendering style, a target texture partition to which the pixel belongs;
determining a color of each pixel on the target object according to color configuration information of the target texture partition, color change information of the target texture partition, and second position information of the pixel on the target object under the target rendering style; and
mapping the color of each pixel on the target object to a region on a display screen.

20. The non-transitory computer-readable storage medium according to claim 19, wherein the method further comprises:
determining a random gray value of each component of the target object; and
obtaining a target component in a preset gray-scale range based on the random gray value, and updating a pixel comprised in the target component to a preset color.
